(19) United States
(12) Patent Application Publication
(10) Pub. No.: US 2007/0174155 A1
(43) Pub. Date: Jul. 26, 2007

(54) Inventory tracking objects

(76) Inventors: Martin von der Emde, Wiesloch (DE); Thomas Hoffmann, Romerberg (DE); Frank Kruger, Heidelberg (DE); Theo Zimmermann, San Ysidro, CA (US); Dietmar Nowotny, Dielheim (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/323,954

(22) Filed: Dec. 30, 2005

(51) Int. Cl. G07F 19/00

(52) U.S. Cl. 705/30

(57) ABSTRACT

A system has a plurality of operational components within a value chain. A due management operational component within the value chain has a due inventory object that provides central storage for payments due from customers. A payment operational component within the value chain has a payment registry inventory object that provides central storage for payments received. Transactions result in messages that update the inventory objects. In one embodiment, prima nota are business documents that are primary copies of documents related to the transactions.

### BACKGROUND

In prior business management computer systems, inventory was kept track of in a database. Many different functions within the system had access to the database, and may have made changes to inventory. It was not well controlled, and it was difficult to obtain a picture in time of the status of the inventory. Complex queries and reports may have been used to obtain inventory information from the database. Further, the ability of different functions within the system to modify the inventory data lead to errors and difficulties in reconciling data with real inventories.

### SUMMARY

A system has a plurality of operational components within a value chain. A due management operational component within the value chain has a due inventory object that may provide central storage for payments due from customers (receivables) and payments due for suppliers (payables) and other payables due for tax and social authorities. A payment operational component within the value chain has a payment registry inventory object that provides central storage for payments received. Due management inventory and payment register inventory may provide unique cash management information.

### BRIEF DESCRIPTION OF THE DRAWINGS

FIG. 1 is a block diagram illustration of a value chain with prima nota and single point inventory objects according to an example embodiment.

FIG. 2 is a flow chart illustrating updating of inventory objects according to an example embodiment.

FIG. 3 is a flow chart illustrating component operations in a value chain of components according to an example embodiment.

FIG. 4 is a block diagram of a computer system for implementing methods of the present invention according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software consists of computer executable instructions stored on computer readable media such as memory or other type of storage devices. The term “computer readable media” is also used to represent any means by which the computer readable instructions may be received by the computer, such as by different forms of electromagnetic transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Select inventory objects are used to track inventory. The inventory objects serve as a single point of inventory for an asset being tracked in one embodiment. A system and method are described that utilize several components that perform functions corresponding to a business operation. The components each keep track of documents in the form of prima nota. Prima nota are source documents related to business agreements, such as orders, delivery details, invoices, payments and other business documents. In addition, components may contain inventory objects that serve to track inventory and provide a single point for such inventory. Components may execute transactions that affect the inventory objects. A separate accounting and finance system may be informed of transactions via messaging.

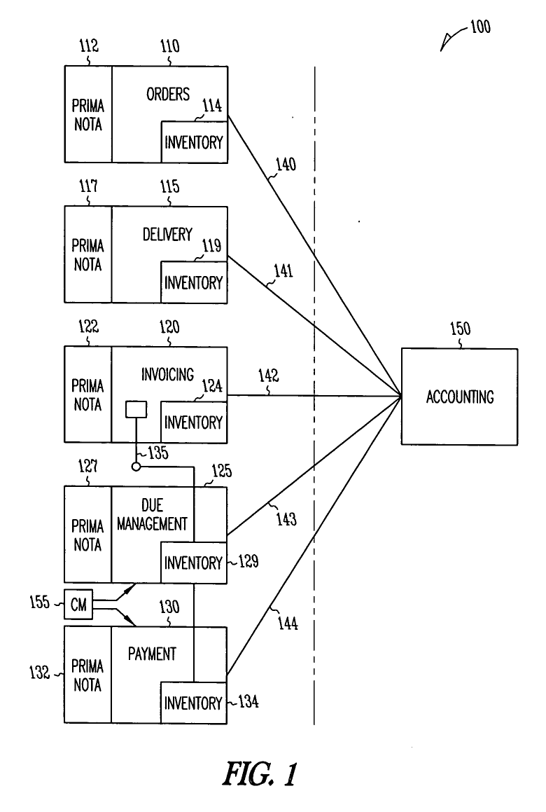

FIG. 1 is a block diagram illustration of a value chain 100 with prima nota and single point inventory objects according to an example embodiment. Selected components in the value chain comprise an orders component, 110, a delivery component 115, an invoicing component 120, a due management component 125 and a payment component 130. Orders component 110 may include prima nota 112 and an order inventory object 114. The prima nota 112 consists of images of original business documents, such as actual customer orders and contracts in one embodiment. These are the original business documents, and in one embodiment, are assigned a unique internal identification or representation such as a string of numbers and/or characters, to ensure proper referencing. While such prima nota 112 are the primary business documents, copies of them may be provided if desired.

Order inventory object 114 may include an inventory of all current unshipped orders in one embodiment. It is updated by the use of messages generated as a result of transactions. A transaction may be performed by the orders component 110 in response to receipt of an order. A message to update the inventory object 114 may also result from a delivery transaction via delivery component 115.

Deliver component 115 may also include prima nota 117 that contains primary business documents, such as delivery documents, and a material inventory 119, which again may be updated via messages generated by transactions from one or more components.

Invoicing component 120 may also include prima nota 122 that contains primary copies of invoices and other business documents related to functions that the invoicing component 120 performs. Invoicing component 120 may not contain a separate inventory object. It reuses the inventory of the due management component 129. Transactions may result in increases and reductions in the inventory of inventory object 129.

Due management component 125 may also include prima nota 127, such as documents related to amounts due from business partners, collections notices, etc. Due management component 125 may also include a due inventory object that represents amounts due from business partners. It may be updated via messages resulting from transactions in various components, such as invoicing via the invoicing component as represented by line 135. It may also be updated by messages generated from payments received via payment component 130.

Payment component 130 may also include prima nota 132, such as documents related to payments. Payments may take many different forms, such as cash, check, money order, credit card, offsets, and electronic funds transfer. The prima nota may be scanned copies of checks, or associated communications with such payments. The payments are transactions that are processed by the payment component 130 and result in messages incrementing and decrementing a payment register inventory object 134.

In one embodiment, the components perform transactions that modify one or more inventory objects, and also may result in communications of such transactions in the form of messages as indicated at 140, 141, 142, 143 and 144 being sent to a separate accounting/finance system 150. The business operations 100 and accounting/finance system 150 are separate systems that communicate back and forth via messages. In one embodiment, the business operations system 100 is a cash based system, where cash is calculated in real time. The accounting system may operate on an accrual basis. By using messages between these two different systems, and keeping business documents and inventory separate in the operations system, each system is free to select how to handle transactions.

One result of this separation is that a cash management function 155, which may not be associated with any of the listed components, may quickly obtain information on the overall cash position of a business implemented by the components. Two inventory objects, the due management inventory object 129 and the payment register inventory object 134 contain representations of a substantial percentage of the cash position of the business. In one embodiment, it is approximately 80% of the cash position of the business. Thus, in a simple operation involving only two messages to these inventory objects, a good indication of the cash position of the business is easily obtained.

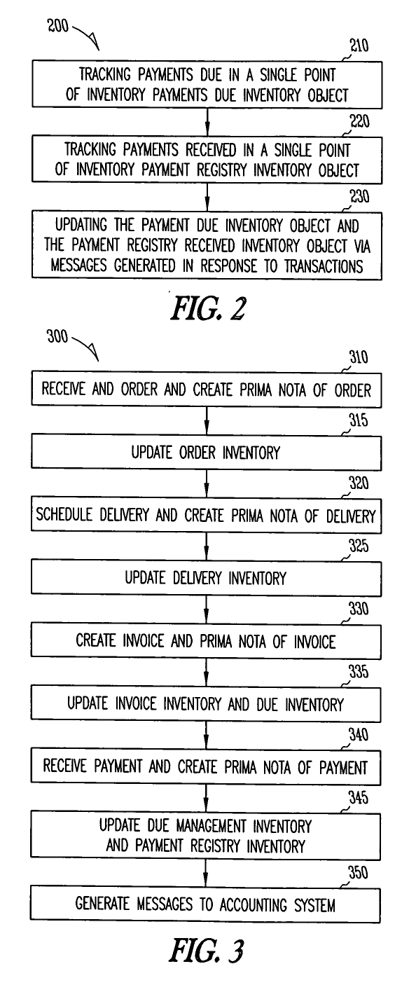

FIG. 2 is a flow chart illustrating updating of inventory objects according to an example embodiment. At 210, payments due are tracked in a single point of inventory payments due inventory object. Transactions resulting in payments due, such as the creation and sending of an invoice to a business partner result in updating of the payments due inventory object. Such updates are caused by messages that are received by the object and invoke methods on the object to increment or decrement payments due. Further methods may be used to obtain totals from the inventory object. In one embodiment, such totals are representative of the cash represented in the object.

At 220, payments received are tracked in a single point of inventory payment registry inventory object. As the payments are received by a component, messages are generated to increment or decrement the inventory payment registry inventory object. Such payments may be payments in full, or partial payments, and the inventory object is modified correspondingly. Further methods may be used to obtain totals from the inventory object. In one embodiment, such totals are representative of the cash represented in the object.

At 230, such updating of the payments due inventory object and the payment registry received inventory object is done via messages generated in response to transactions. As indicated above, the transactions may be related to invoices being generated, and invoices being paid partially or fully. In further embodiments, components may send messages resulting from transactions to the separate accounting system, which may be based on a different accounting method.

FIG. 3 is a flow chart illustrating component operations in a value chain of components according to an example embodiment. At 310, an order is received and prima nota of the order may be created. The prima nota may consist of a scanned or electronic copy of the order in one embodiment. At 315, the order inventory may be updated. At 320, a delivery of the order may be scheduled, and prima nota of delivery documents may be created. At 325, the material inventory may be updated. At 330, an invoice and prima nota for the invoice may be created. The due inventory may be updated at 335. When payment is received, prima nota of payment may be created, and at 345, due management inventory and payment registry inventory may be updated. Messages to the accounting system may be generated as a result of selected transactions at 350.

In this manner, single locations may contain the exact inventory for the selected asset. When the due management inventory and payment register inventory objects are queried, they provide a view of the cash situation of the business, accounting for about 80% of cash in one embodiment.

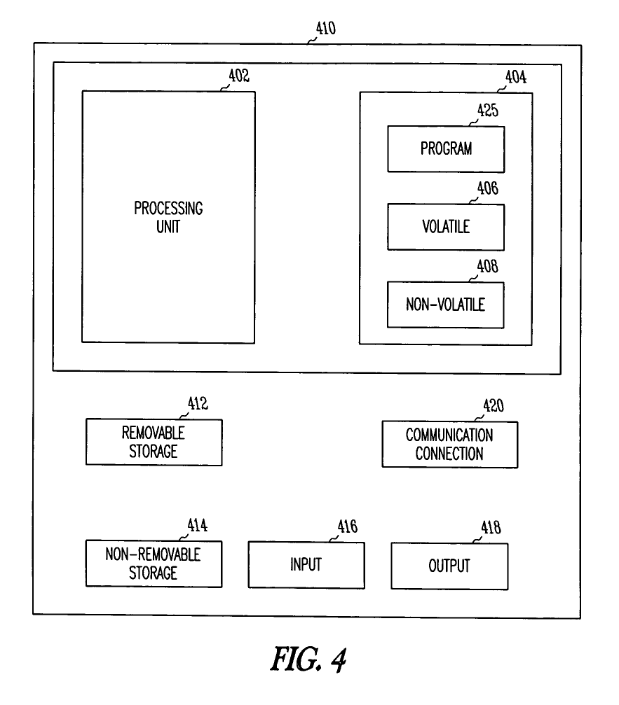

A block diagram of a computer system that executes programming for performing the above functions is shown in FIG. 4. In one embodiment, multiple such computer systems are utilized in a distributed network to implement multiple components in a transaction based environment. An object oriented architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a computer-readable medium. The term “computer readable medium” is also used to represent electromagnetic transmission of the software. For example, a computer program 425 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 410 to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A system comprising:
a plurality of operational components within a value chain;
a due management operational component within the value chain having a due inventory object that provides central storage for payments due from customers; and
a payment operational component within the value chain having a payment registry inventory object that provides central storage for payments received.

2. The system of claim 1 wherein the due inventory object and payment registry inventory object in combination provide a substantial view of cash.

3. The system of claim 1 wherein the due inventory object provides a single point of inventory for payments due.

4. The system of claim 1 wherein the payment registry inventory object provides a single point of inventory for payments received.

5. The system of claim 1 wherein the plurality of operational components comprise prima nota copies of business documents.

6. The system of claim 5 wherein the plurality of operational components process transactions that create messages to update inventory objects.

7. The system of claim 1 wherein the operational components within the value chain comprise an order component, a delivery component and an invoicing component.

8. The system of claim 7 wherein an invoicing component invoice transaction generates a message to update the due inventory object to reflect the invoice transaction.

9. The system of claim 7 wherein the payment component received payment transaction generates a message to update the due management inventory object and the payment registry inventory object.

10. The system of claim 1 and further comprising an accounting system that is separate from the operational components and communicates with the operational components via messaging.

11. The system of claim 1 wherein the operational components maintain exclusive control of their respective prima nota, and selectively provide copies of such prima nota to other components.

12. A system comprising:
a due management operational component within a value chain having a due inventory object that provides central storage for payments due from customers; and
a payment operational component within the value chain having a payment registry inventory object that provides central storage for payments received.

13. The system of claim 13 wherein operational components comprise prima nota business documents, and means for generating transactions based on such business documents.

14. The system of claim 14 wherein the transactions generate messages acting on the inventory objects of various components.

15. The system of claim 13 and further comprising an order component having prima nota orders and an order inventory object, a delivery component having prima nota delivery documents and a delivery inventory object, and an invoicing component having prima nota invoices and an invoice inventory object.

16. A method comprising:
tracking payments due in a single point of inventory payments due inventory object;
tracking payments received in a single point of inventory payment registry inventory object; and
updating the payments due inventory object and the payment registry received inventory object via messages generated in response to transactions.

17. The method of claim 16 wherein payments received in multiple different forms result in the generation of messages to update the payments due inventory object and the payment registry inventory object.

18. The method of claim 17 wherein the different forms of payments are selected from the group consisting of cash, check, money order, credit card, offsets, and electronic funds transfer.

19. The method of claim 16 wherein payments due are processed in a due management component, and payments received are processed in a payment component.

20. The method of claim 19 wherein the due management and payment components generate messages that are reflective of transactions, and send such messages to a separate accounting and financial system.
